(19) United States
(12) Patent Application Publication
(10) Pub. No.: US 2026/0154123 A1
(43) Pub. Date: Jun. 4, 2026

(54) SYSTEM AND METHODS FOR MANAGING LINKED DATA RECORDS ASSOCIATED WITH A RESOURCE ACCOUNT

(71) Applicant: The Toronto-Dominion Bank, Toronto (CA)

(72) Inventors: Francis James Alexander GUTTRIDGE, Toronto (CA); Michael Gregory McCANN, Mississauga (CA); Kishore Chandradev Reddy PALLE, Cherry Hill, NJ (US); Dino Paul D'AGOSTINO, Richmond Hill (CA); Jonathan Richard Channing RICHARDS, Toronto (CA); Lakshmipriya PALLE, Cherry Hill, NJ (US); Edward William RATCLIFFE, Toronto (CA); Parixit D. GANDHI, Brampton (CA)

(73) Assignee: The Toronto-Dominion Bank, Toronto (CA)

(21) Appl. No.: 18/964,766

(22) Filed: Dec. 2, 2024

(51) Int. Cl. G06F 9/50; G06F 16/23

(52) U.S. Cl. CPC G06F 9/505; G06F 16/23

(57) ABSTRACT

A computer-implemented method is disclosed. The method includes: monitoring operations of a resource account, the resource account being associated with a first data record containing resources of a first type and a second data record containing resources of a second type; detecting a trigger based on monitoring the operations; in response to detecting the trigger: determining a first quantity of resources of the first type for converting to the second resource type based on defined resource transfer rules; converting the first quantity of the resources of the first type to a second quantity of resources of the second type; and causing a transfer of the second quantity of the resources of the second type to the second data record.

### TECHNICAL FIELD

The present application relates to account management platforms and, more particularly, to a system and methods for managing linked data records associated with a resource account.

### BACKGROUND

A resource account management system (RAMS) is often employed to handle complex account management mandates. Resource accounts that experience high volumes of account activity face several challenges related to performance, security, and operational efficiency.

### BRIEF DESCRIPTION OF THE DRAWINGS

Embodiments are described in detail below, with reference to the following drawings:

FIG. 1 is a schematic diagram illustrating an example operating environment;

FIG. 2 illustrates an example system architecture of a loyalty management system;

FIG. 3A is high-level schematic diagram of an example computing device;

FIG. 3B shows a simplified organization of software components stored in a memory of the example computing device of FIG. 3A;

FIG. 4 shows, in flowchart form, an example method for controlling transfer of resources between linked data records associated with a resource account;

FIG. 5 shows, in flowchart form, an example method for managing linked data records associated with a resource account;

FIG. 6 shows, in flowchart form, an example method for controlling access to a data record; and

FIG. 7 shows, in flowchart form, another example method for managing linked data records associated with a resource account.

Like reference numerals are used in the drawings to denote like elements and features.

### DETAILED DESCRIPTION OF VARIOUS EMBODIMENTS

In an aspect, a computing system is disclosed. The computing system includes a processor and a memory coupled to the processor. The memory stores computer-executable instructions that, when executed by the processor, configure the processor to: monitor operations of a resource account, the resource account being associated with a first data record containing resources of a first type and a second data record containing resources of a second type; detect a trigger based on monitoring the operations; in response to detecting the trigger: determine a first quantity of resources of the first type for converting to the second resource type based on defined resource transfer rules; convert the first quantity of the resources of the first type to a second quantity of resources of the second type; and cause a transfer of the second quantity of the resources of the second type to the second data record.

In some implementations, detecting the trigger may include determining that a required transfer of a defined minimum quantity of resources of the second type to the second data record has not been received by a specified time.

In some implementations, detecting the trigger may further include determining that the first data record contains sufficient quantity resources of the first type for converting to the minimum quantity of resources of the second type and the second quantity may be equal to the minimum quantity.

In some implementations, detecting the trigger comprises: determining that a transfer of a minimum quantity of resources of the second type to the second data record is required by a specified time; and detecting a transfer of resources to the second data record that is less than the minimum required quantity.

In some implementations, the first resources may comprise digital resources that are allocated to the resource account based on historical account operations.

In some implementations, the defined resource transfer rules may indicate a rate of conversion between resources of the first type and resources of the second type.

In some implementations, converting the first quantity of the resources of the first type to the second quantity of resources of the second type may include modifying the first data record to represent an adjustment of resources of the first type associated with the resource account.

In some implementations, the defined resource transfer rules may indicate a maximum quantity of resources of the first type that is available for converting to resources of the second type.

In some implementations, causing the transfer of the second quantity of the resources of the second type may include incrementing a quantity of resources contained in the second data record based on the transfer.

In some implementations, the resource account may be associated with a value transfer card and the second data record may include an indication of an outstanding balance associated with the value transfer card.

In another aspect, a computer-implemented method is disclosed. The method includes: monitoring operations of a resource account, the resource account being associated with a first data record containing resources of a first type and a second data record containing resources of a second type; detecting a trigger based on monitoring the operations; in response to detecting the trigger: determining a first quantity of resources of the first type for converting to the second resource type based on defined resource transfer rules; converting the first quantity of the resources of the first type to a second quantity of resources of the second type; and causing a transfer of the second quantity of the resources of the second type to the second data record.

In another aspect, a non-transitory computer readable storage medium is disclosed. The computer readable storage medium contains instructions thereon which, when executed by a processor, configure the processor to: monitoring operations of a resource account, the resource account being associated with a first data record containing resources of a first type and a second data record containing resources of a second type; detecting a trigger based on monitoring the operations; in response to detecting the trigger: determining a first quantity of resources of the first type for converting to the second resource type based on defined resource transfer rules; converting the first quantity of the resources of the first type to a second quantity of resources of the second type; and causing a transfer of the second quantity of the resources of the second type to the second data record.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

A resource account management system (RAMS) is a computing system that handles, monitors, and manages resource accounts. Various different types of resources may be managed by a RAMS, such as computing resources (e.g., memory, processing units), digital resources, stored value, and the like. The functions of a RAMS include transaction processing, data management and storage, access control, API integration, and account monitoring and control. Other systems (e.g., CRM, loyalty management, or ERP system) may integrate with a RAMS to leverage secure and efficient management of existing resource accounts.

RAMS are particularly useful as a tool for managing accounts that have a high-volume of account activity. High transaction volumes can complicate numerous functions of a RAMS, such as fraud detection and transaction authorization. A resource account may be subject to rules defining various conditions or events that are designated to trigger corresponding “account actions”. An account action may be an action for rectifying a detected condition, such as a deficiency or error, or event associated with a resource account. For example, if a “low resource level” condition is detected, an account action for replenishing the resources of the account may be executed. As another example, if a “suspicious account activity” event is detected, an account action for cancelling or holding all or a subset of pending transactions may be executed. The ability of a single computing system to track conditions/events in real-time while also processing high volumes of account activity may be limited. For example, a RAMS may fail to detect one or more defined conditions/events for an account, resulting in the associated account actions being unintentionally delayed or omitted.

Even when a RAMS is able to detect a defined condition or event, the resource account itself may not be suited to support the account action(s) that are triggered. For example, an account may contain insufficient resources for an outbound resource transfer that is intended to be triggered by a detected event (e.g., a bill payment deadline). The failure to promptly execute such account actions may lead to account data inconsistencies and errors in processing transactions.

One possible approach to addressing the technical challenges of managing high transaction volume accounts is implementing a distributed system to handle account actions. Distributed systems can improve performance by increasing computational speed and data reliability. By way of example, an implementation of RAMS may comprise multiple computing systems that individually executes account actions of a resource account while collectively ensuring robust transaction processing for the account. A resource account may be associated with multiple different data records, and the data records may be managed by a plurality of computing systems. In particular, where the data records are associated with different resource types, a RAMS may assign the data records to different computing systems for processing based on their resource type.

An illustrative example of a pair of data records that are associated with a single resource account include a cardholder account for a value transfer card and a loyalty points account that is linked to the cardholder account. Value transfer cards, such as payment cards, can be used for making purchases at a point-of-sale or to access ATMs for account-related transactions. A value transfer card may be connected to one or more accounts (such as bank accounts) storing data and/or resources that are accessible to the cardholder. For example, a value transfer card may be associated with a primary, or default, account and a number of secondary accounts that can be used for specific transactions (e.g., foreign currency transactions). Any transaction that is initiated using a value transfer card may access resources of one of the accounts that are connected to the value transfer card.

A value transfer card may be associated with both (1) a bank account, and (2) a loyalty program that is designed to reward cardholders for use of the card. When a value transfer card is used to complete a transaction, such as a purchase, bill payment, etc., a loyalty points account associated with the card may be credited with “loyalty points”, which are a digital representation of user engagement rewards within a loyalty management system. These points can, in turn, be exchanged, or redeemed, for rewards, discounts, or services, subject to specific redemption rules. For example, the rewards may be in the form of products (e.g., merchandise, gift cards, services, etc.) offered by third-party entities that are affiliated with the loyalty program, or they may be exchanged for loyalty points of other rewards programs.

A backend system for a cardholder account (e.g., a card issuer system) may cooperate with a computing system administering a loyalty points account (i.e., a loyalty management system) to ensure that account actions for the cardholder account that are triggered by defined events/conditions for the account are executed in a timely and efficient manner. By way of example, upon detecting that an outstanding balance is payable for a cardholder account, a loyalty management system may be configured to process rules for automatically applying points of a loyalty points account towards payment of the balance. More generally, in accordance with example embodiments of the present disclosure, a distributed system may be implemented to handle account actions in connection with one or more of a plurality of data records that are associated with a resource account.

Various solutions for addressing the aforementioned technical challenges associated with RAMS are described in the present disclosure.

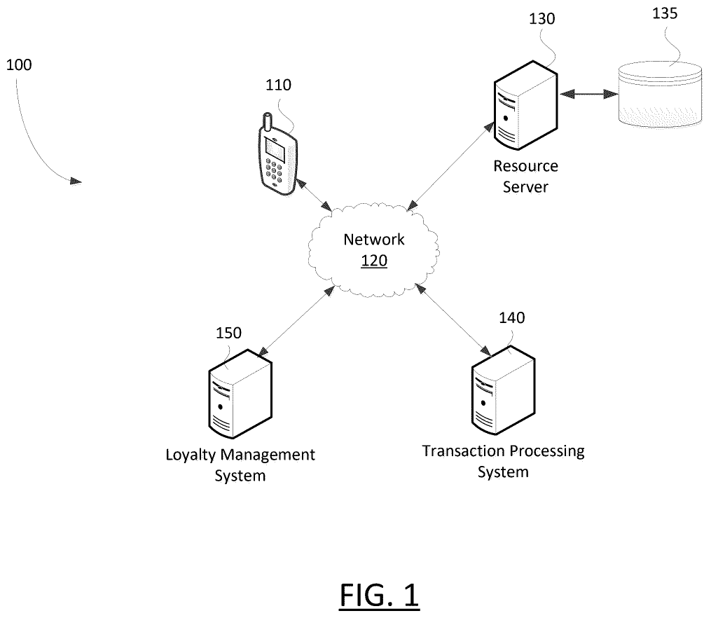

Reference is first made to FIG. 1, which is a schematic diagram illustrating an exemplary computing environment 100 consistent with certain disclosed embodiments. As shown in FIG. 1, the computing environment 100 may include one or more client devices 110, a resource server 130, a database 131 associated with the resource server 130, a transaction processing system 140, a loyalty management system 150, and a communications network 120 connecting one or more of the components of computing environment 100.

The resource server 130 is a server computer system. The resource server 130 and the client devices 110 communicate via the network 120. In at least some embodiments, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 may be associated with a client entity (e.g., an individual, an organization, etc.) having resources that are managed by or via the resource server 130. For example, the resource server 130 may be a financial institution server and the client entity may be a customer of a financial institution operating the resource server 130. The client device 110 may store software instructions that cause the client device to establish communications with the resource server 130 and, in at least some embodiments, a loyalty management system 150.

The resource server 130 may track, manage, and maintain resources, make lending decisions, and/or lend resources to a client entity associated with the client device 110. The resources may, for example, comprise computing resources (e.g., processor cycles, memory, etc.), digital resources, stored value (e.g., fiat currency), and the like. In at least some implementations, the resources may be represented in a database. For example, the resource server 130 may be coupled to a database 135, which may be provided in secure storage. The secure storage may be provided internally within the resource server 130 or alternatively, it may be provided remotely from the resource server 130. For example, the secure storage may include one or more data centers that store data with bank-grade security.

The database 135 may include data records for a plurality of accounts and at least some of the data records may define a quantity of resources associated with the client entity. For example, the client entity may be associated with an account having one or more data records in the database 135. The data records may reflect a quantity of stored resources that are associated with the client entity. Such resources may include owned resources and, in at least some embodiments, borrowed resources (e.g., resources available on credit). The quantity of resources that are available to or associated with the client entity may be reflected by a balance defined in an associated data record such as, for example, a bank balance.

In at least some embodiments, the database 135 may store various types of information in connection with customers of a business entity that administers the resource server 130. For example, the database 135 may store customer profile data and financial account data associated with customers. The customer profile data may include, without limitation, personal information of registered customers, authentication credentials of the customers, account identifying information (e.g., checking account, savings account, revolving credit line, etc.), and information identifying services (e.g., banking services, investment management services, etc.) and/or programs (e.g., loyalty programs) that are offered to the customers by the business entity. The financial account data may include account balances, historical transaction data, credit score(s), mortgage balances, investment account balances, and portfolio data relating to portfolios of investments that are held by customers, among others.

The business entity associated with the resource server 130 may provide services that are accessible to the client entity. For example, the business entity may provide account management services, financial transaction services, investment management services, etc. for the client entity. In at least some embodiments, the business entity may issue value transfer cards (e.g., credit, charge or debit cards) to its customers, including the client entity. In particular, the resource server 130 may be associated with a value transfer card issuer. The value transfer cards issued by the business entity may be associated with resource accounts (of the customers) at the resource server 130. For example, the value transfer cards may be used by customers to access resources of their accounts.

The resource server 130 may be configured to provide a user interface that allows client devices 110 to access the services offered by the business entity. By way of example, the resource server 130 may be configured to provide a website or web-based portal which can be accessed via the client devices 110. The website (or portal) may include web content corresponding to various services offered by the business entity, and the resource server 130 may provide the web content for display on the client devices 110. As another example, the resource server 130 may be associated with a software application which may be installed and/or run on the client devices 110. More specifically, the resource server 130 may implement the backend of an application (e.g., a mobile app) that is used for accessing the services offered by the business entity.

The computing environment 100 also includes a loyalty management system 150. The loyalty management system 150 is a computing system associated with a loyalty program. In some embodiments, the loyalty management system 150 may be administered by a business entity that is associated with the resource server 130 (e.g., a financial institution). For example, the business entity may offer various loyalty programs to its customers, and the loyalty management system 150 may be associated with one of the loyalty programs. In particular, the loyalty management system 150 may be implemented by or as part of the resource server 130.

The loyalty programs may, for example, be linked to value transfer cards that are offered to customers of the business entity. A customer may register or sign up for a value transfer card that is offered by the business entity, and the value transfer card can be connected to a loyalty program. When the customer uses the value transfer card to complete a transaction (e.g., purchases, bill payments, etc.), the loyalty management system 150 validates the transaction against loyalty rules, calculates loyalty points based on the transaction value and rule parameters, and credits a loyalty program account associated with the customer by adding the calculated points to the customer's loyalty balance.

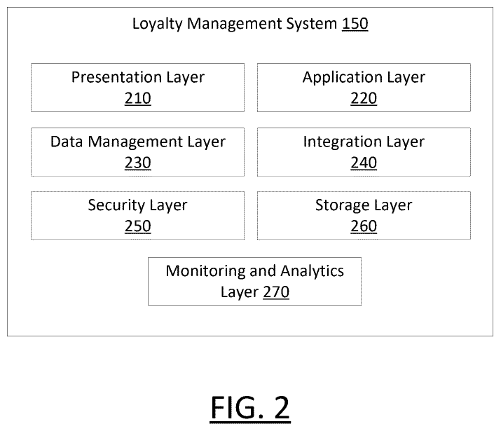

The loyalty management system 150 implements various functions relating to a loyalty program. In particular, the loyalty management system 150 may track, manage, and maintain loyalty points information for a plurality of accounts associated with the loyalty program. FIG. 2 illustrates an example system architecture of a loyalty management system. The application layer 210 comprises the core business logic of the loyalty management system 150. The application layer 210 defines logic for awarding points based on activities (e.g., transactions) and manages rules for redeeming points, such as conditions for reward eligibility and a mechanism for deducting points. A rules engine that automates reward calculations may be integrated into the application layer 210. Messages are sent (via email, in-app notifications, etc.) in real-time to notify customers of their points activity and redemptions.

The data management layer 220 stores and manages customer data, including customer profiles and preferences. The loyalty transactions of customers, such as points accrual, redemption, and adjustments, are tracked and recorded, for example, in a ledger maintained by the data management layer 220. The data management layer 220 may provide analytics on customer engagement and usage patterns, and assess the effectiveness of the loyalty point program.

The presentation layer 230 provides a user interface that enables front-end access for customers and administrators. End-users may use a customer portal (e.g., mobile app, API endpoint, etc.) to view their loyalty points, redeem rewards, or participate in campaigns. An administrator dashboard may be implemented by the presentation layer 230, providing an interface for administrators to manage their loyalty programs, configure rules, and monitor analytics.

Data is exchanged between the loyalty management system 150 and other business systems. The integration layer 240 enables API integrations with RAMS, CRMs, point-of-sales, e-commerce platforms, inventory systems, and the like. For example, the integration layer 240 may support: synchronizing customer data across multiple systems; real-time capture of transaction and points data; and sharing points and rewards data with affiliates.

The loyalty management system 150 may be communicably connected with computing systems associated with third-party affiliates that support the loyalty programs. For example, the loyalty management system 150 may obtain, via the network 120, product data of rewards (e.g., merchandise, services, etc.) that are offered by the affiliates. In particular, the loyalty management system 150 may obtain product data of a catalogue of products for which customers can redeem their loyalty points. The product data may be obtained by, for example, querying databases associated with the affiliates and/or by using defined API calls for the affiliate systems. The loyalty management system 150 may obtain the product data periodically or on-demand, and store the product data in association with the corresponding loyalty program.

The integrated system architecture that includes the transaction processing system 140 and the loyalty management system 150 provides a robust environment for managing customer transactions and loyalty points simultaneously. The transaction processing system 140 implements an authorization engine that manages transaction authorizations. In particular, transactions may be authorized in real-time by verifying cardholder credentials, balance, and fraud checks. Customer transactions are tracked by the transaction processing system 140, and customer accounts are updated in real-time to reflect changes to account balance. The transaction data is provided (e.g., via the integration layer 240) to the loyalty management system 140 such that loyalty points can be calculated. Further, the transaction processing system 140 handles transaction clearing to ensure funds are correctly debited/credited.

The client device 110, the resource server 130, the transaction processing system 140, and the loyalty management system 150 may be in geographically disparate locations. Put differently, the client device 110 may be remote from at least one of: the resource server 130, the transaction processing system 140, and the loyalty management system 150. As described above, each of the client device 110, the resource server 130, the transaction processing system 140, and the loyalty management system 150 may be a computer system.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like. Additionally, or alternatively, the network 120 may be or may include one or more payment networks. The network 120 may, in some embodiments, include a plurality of distinct networks. For example, communications between certain of the computer systems may be over a private network whereas communications between other of the computer systems may be over a public network, such as the Internet.

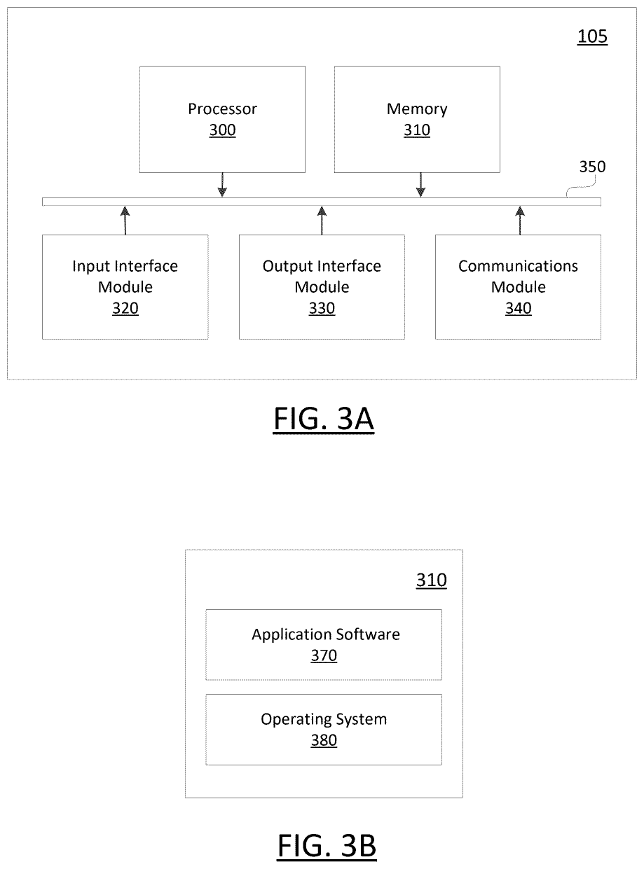

FIG. 3A is a high-level operation diagram of an example computing device 105. In at least some embodiments, the example computing device 105 may be exemplary of one or more of: the client device 110, the resource server 130, the transaction processing system 140, and the loyalty management system 150. The example computing device 105 includes a variety of modules. For example, as illustrated, the example computing device 105, may include a processor 300, a memory 310, an input interface module 320, an output interface module 330, and a communications module 340. As illustrated, the foregoing example modules of the example computing device 105 are in communication over a bus 350.

The processor 300 is a hardware processor and may, for example, be one or more ARM, Intel x86, PowerPC processors or the like.

The memory 310 allows data to be stored and retrieved. The memory 310 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 320 allows the example computing device 105 to receive input signals. Input signals may, for example, correspond to input received from a user. The input interface module 320 may serve to interconnect the example computing device 105 with one or more input devices. Input signals may be received from input devices by the input interface module 320. Input devices may, for example, include one or more of a touchscreen input, keyboard, trackball or the like. In some embodiments, all or a portion of the input interface module 320 may be integrated with an input device. For example, the input interface module 320 may be integrated with one of the aforementioned input devices.

The output interface module 330 allows the example computing device 105 to provide output signals. Some output signals may, for example allow provision of output to a user. The output interface module 330 may serve to interconnect the example computing device 105 with one or more output devices. Output signals may be sent to output devices by output interface module 330. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 330 may be integrated with an output device. For example, the output interface module 330 may be integrated with one of the aforementioned output devices.

The communications module 340 allows the example computing device 105 to communicate with other electronic devices and/or various communications networks. For example, the communications module 340 may allow the example computing device 105 to send or receive communications signals. Communications signals may be sent or received according to one or more protocols or according to one or more standards. For example, the communications module 340 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 340 may allow the example computing device 105 to communicate using near-field communication (NFC), via Wi-Fi™, using Bluetooth™ or via some combination of one or more networks or protocols. Contactless payments may be made using NFC. In some embodiments, all or a portion of the communications module 340 may be integrated into a component of the example computing device 105. For example, the communications module may be integrated into a communications chipset.

Software comprising instructions is executed by the processor 300 from a computer-readable medium. For example, software may be loaded into random-access memory from persistent storage of memory 310. Additionally, or alternatively, instructions may be executed by the processor 300 directly from read-only memory of memory 310.

FIG. 3B depicts a simplified organization of software components stored in memory 310 of the example computing device 105. As illustrated, these software components include an operating system 380 and application software 370.

The operating system 380 is software. The operating system 380 allows the application software 370 to access the processor 300, the memory 310, the input interface module 320, the output interface module 330 and the communications module 340. The operating system 380 may be, for example, Apple iOS™, Google's Android™, Linux™, Microsoft Windows™, or the like.

The application software 370 adapts the example computing device 105, in combination with the operating system 380, to operate as a device performing particular functions. For example, the application software 370 may cooperate with the operating system 380 to adapt a suitable embodiment of the example computing device 105 to operate as the client device 110, the resource server 130, the transaction processing system 140, or the loyalty management system 150 The application software 370 may, for example, include a resource account management application. In some example implementations, a resource account management application may allow users to access and control various aspects of their accounts, for example, at a resource server. For example, the resource account management application may comprise a mobile banking application for managing personal or business bank accounts. A resource account management application may provide a functionality of managing features of value transfer cards that are associated with resource accounts (and data records of those resource accounts). In particular, customers of a financial institution may use a resource account management application on their devices to access card data of their value transfer cards, such as current balance, transactions history, accumulated loyalty points, etc.

While a single application software 370 is illustrated in FIG. 3B, in operation, the memory 310 may include more than one application software 370 and different application software 370 may perform different operations.

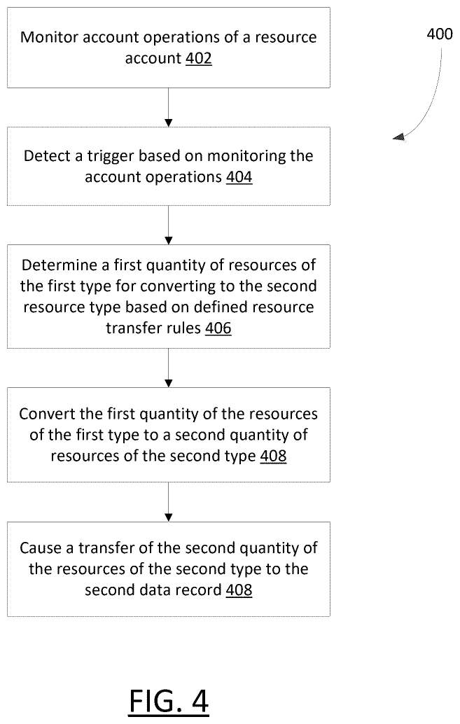

Reference is now made to FIG. 4 which shows, in flowchart form, an example method 400 for controlling transfer of resources between linked data records associated with a resource account. The method 400 may be implemented by a computing system associated with a loyalty program. In particular, the computing system may be configured to access and manage account data of loyalty program accounts. For example, the method 400 may be implemented by a standalone computing system, such as the loyalty management system 150 of FIG. 1, that is configured for performing functions relating to administering loyalty programs. As another example, the method 400 may be implemented by a resource account management system, such as the resource server 130 of FIG. 1, that integrates functionalities of a loyalty system. Operations 402 and onward may be performed by one or more processors of a computing device such as, for example, the processor 300 (FIG. 3A) of suitably configured instances of the example computing device 105 (FIG. 3A).

The computing system monitors account activities of a resource account in real-time (operation 402). The account activities may include account-related operations (e.g., transactions such as deposits, withdrawals, purchases, internal/external transfers, etc.) that are conducted in connection with the resource account. The resource account may be associated with a plurality of data records, and the account activities may relate to one or more of the data records.

The data records may contain resources of different types. In particular, the resource account is associated with, at least, a first data record containing resources of a first type and a second data record containing resources of a second type. The first data record and the second data record are linked. For example, the first data record may comprise digital resources (e.g., loyalty points) that accrue as a result of historical operations (e.g., card transactions) conducted in connection with the second data record. More generally, the first data record may comprise resources that accrue based on account activities associated with the linked second data record. Each of the first and second data records may maintain a comprehensive log of transactions and account activities as well as other data record-specific indicators (e.g., loyalty points balance, card balance, etc.).

The first and second data records are managed by different computing systems. The linking of the first and second data records may allow for leveraging a distributed system to process account actions associated with one or both of the data records. The resource account may be subject to rules defining various conditions or events that are designated to trigger corresponding “account actions”. An account action may, for example, be an action for rectifying a detected condition, such as a deficiency or error, or an action prompted by a detected event associated with a data record. A distributed system can deploy multiple computing systems (as contrasted with a single computing system) to handle account actions for a plurality of data records associated with a resource account. In this way, the distributed system may facilitate improved performance (e.g., parallel processing, distributed workloads, etc.) and resource sharing in managing multiple linked data records.

In operation 404, the computing system detects a defined trigger for the second data record based on monitoring the account activities associated with the resource account. The trigger may be a condition, status, or event that, upon its detection, is intended to cause certain account action(s) to be executed. In at least some implementations, the trigger may relate to transfer of resources to or from the second data record. By way of example, a trigger may be detected when the computing system determines that a required transfer of resources associated with the second data record is not received by the computing system within a specified time. A definition of the trigger may indicate a defined minimum quantity of resources for the transfer and a time parameter (e.g., due date for the transfer). In the context of a value transfer card, if the computing system does not receive, by a specified date, a minimum required payment towards an outstanding balance of a data record (i.e., cardholder account) associated with the value transfer card, a trigger condition may be detected.

Upon detecting such trigger, the computing system is configured to coordinate with a loyalty management system managing the first data record to process a transaction (e.g., payment towards outstanding balance) in connection with the second data record. For example, the accrued loyalty points of the first data record may be used to automatically pay all or part of an outstanding balance of the value transfer card. The loyalty points may first be converted to a monetary value (using a suitable rate of conversion), and this money can be transferred to the second data record for payment of the outstanding balance.

In some implementations, the transaction may be processed only if the first data record contains sufficient resources for the account action. For example, the computing system may determine whether the first data record contains sufficient quantity of resources of the first type for converting to the minimum quantity of resources of the second type; the transaction (i.e., loyalty points conversion and balance payment) may be processed only if the computing system determines that the first data record contains sufficient resources of the first type. Additionally, or alternatively, the computing system may be configured to determine whether the quantity of resources associated with the first data record is greater than a defined minimum threshold. The transaction may be processed only if the quantity of resources does exceed the minimum threshold.

Other conditions or events may be defined for the second data record in order to trigger account actions, which are then are assigned to be handled by a computing system associated with the first data record. For example, in some implementations, a trigger may be detected when the computing system determines that a transfer of a minimum quantity of resources of the second type is required to be received by a specified time and/or detects a transfer of resources to the second data record that is less than the minimum required quantity. In the context of a value transfer card, the computing system may detect a trigger if a minimum required payment towards an outstanding balance has not been fully paid off by a specified deadline. As a further example of a trigger, the computing system may detect the trigger upon determining that an outstanding balance associated with a value transfer card satisfies a certain condition. For example, if the outstanding balance is determined to exceed a defined threshold, a trigger may be detected, setting off one or more account actions.

In response to detecting the trigger, the computing system determines a first quantity of resources of the first type for converting to the second resource type. The first quantity is determined based on defined resource transfer rules (operation 406). The resource transfer rules specify, for different triggers and/or account actions, how much of the resources of the first type to convert automatically to the second resource type. The resource transfer rules may indicate, for example, a maximum quantity of resources of the first type that is permitted to be converted to resources of the second type. In particular, the resource transfer rules may specify an upper limit on the quantity (or percentage) of resources that can be allocated towards any transfer action. Additionally, or alternatively, the resource transfer rules may also indicate a rate of conversion (e.g., a dynamic exchange rate) between resources of the first type and resources of the second type. In the context of minimum payments for value transfer cards, the first quantity may represent the entirety or part of a difference between a minimum required payment for a defined time period (e.g., monthly) and an amount that has already been paid by the customer towards the outstanding balance.

In operation 408, the computing system causes the first quantity of the resources of the first type to be converted to a second quantity of resources of the second type. The conversion is conducted using an exchange rate (dynamic or static) between the resources of the first type and resources of the second type. In at least some implementations, the computing system modifies the first data record to represent an adjustment of resources of the first type associated with the resource account. For example, the converted quantity of resources of the first type (e.g., loyalty points) may be deducted from an accumulated balance associated with the first data record.

The computing system then causes a transfer of the second quantity of the resources of the second type to the second data record (operation 410). The resources of the second type may, for example, comprise digital resources that can be transferred via communication networks (e.g., transfer or payment rails). In some implementations, the computing system may increment a quantity of resources contained in the second data record. That is, the “transfer” of the resources of the second type may be represented as a modification of the second data record. For example, where the second data record is associated with an outstanding balance (e.g., a value transfer card balance), the transfer of the second quantity of the resources of the second type results in a corresponding reduction in the balance.

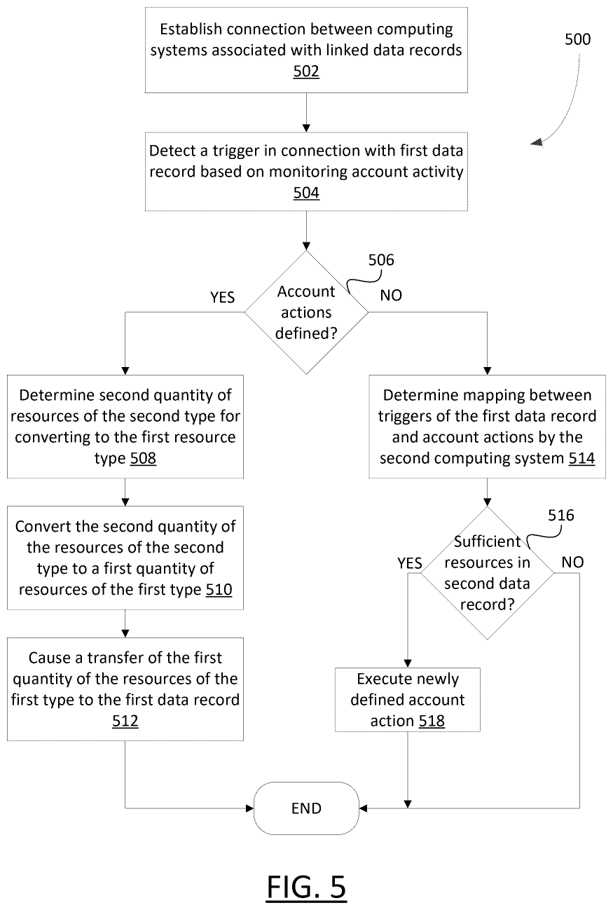

Reference is now made to FIG. 5 which shows, in flowchart form, an example method 500 for managing linked data records associated with a resource account. The method 500 may be implemented by a standalone computing system, such as the loyalty management system 150, or by a resource account management system, such as the resource server 130, that is configured to integrate loyalty system functionalities. Operations 502 and onward may be performed by one or more processors of a computing device such as, for example, the processor 300 (FIG. 3A) of suitably configured instances of the example computing device 105 (FIG. 3A). The operations of method 500 may be performed in addition to, or as alternatives of, one or more of the operations of method 400.

A resource account may be associated with a plurality of data records of different resource types, and each data record may be managed by a different computing system. By establishing a connection between the computing systems, the corresponding data records can be “linked”. This linking of data records can, in turn, allow for leveraging a distributed system comprising multiple computing systems to process account actions associated with one or more of the data records. In operation 502, a connection is established between computing systems managing linked data records associated with a resource account. The data records may, for example, comprise a cardholder account and a loyalty points account associated with a value transfer card. Both accounts may be associated with a single resource account (e.g., a customer's bank account) at a resource server. The cardholder account may be managed by a backend system for a value transfer card and the loyalty points account may be managed by a loyalty management system.

The computing system detects a trigger in connection with a first one of the linked data records (e.g., a cardholder account) based on monitoring account activity for the resource account (operation 504). As described above, a trigger may be a condition, status, or event associated with a data record that is designated to cause certain account action(s) to be executed in connection with the data record. The first data record is associated with a first computer server. For the detected trigger, the computing system determines the account actions that are triggered and whether said account actions may be executed by the second computer server, in operation 506. That is, the computing system assesses whether any of the triggered account actions can be delegated to the second computer server for execution.

If there are account actions that can be performed by a second computer server associated with the second data record, the computing system causes the second computer server to execute the account actions in response to detecting the trigger. The second computer server (and not the first computer server) executes account actions corresponding to a trigger detected for the first data record. In this way, the processing load of (1) detecting conditions/events associated with a data record, and (2) performing account actions pursuant to the detected conditions/events can be distributed among multiple connected computing systems. For example, the first computer server may detect a trigger associated with the first data record while a second computer server, different from the first computer server, may initiate account actions (e.g., corrective actions associated with a detected condition, status, etc.) pursuant to the detected trigger.

The detected trigger may relate to a resource transfer in connection with the first data record. For example, a trigger may be detected when the computing system determines that a required (minimum) transfer of resources is not received by the computing system within a specified time. In operation 508, the computing system determines a second quantity of resources of a second type (i.e., resources of the second data record) for converting to the first resource type. The second quantity is determined based on defined resource transfer rules. The resource transfer rules may indicate, for example, a maximum quantity of resources of the second type that is permitted to be converted to resources of the first type. In particular, the resource transfer rules may specify an upper limit on the quantity of resources that can be allocated towards any account action. The upper limit may be an absolute limit for the account action or a limit that is defined for a certain time period (e.g., a weekly or monthly limit). Additionally, or alternatively, the defined resource transfer rules may indicate a rate of conversion (e.g., a dynamic exchange rate) between resources of the first type and resources of the second type. The rate of conversion may be defined manually and stored in memory, or it may be a rate that is updated dynamically.

The computing system then causes the second quantity of the resources of the second type to be converted a first quantity of resources of the first type (operation 510). In particular, the second data record may be modified to reflect an adjustment in the quantity of resources by, for example, deducting from an accumulated balance associated with the second data record. The first quantity of the resources of the first type is then caused to be transferred to the first data record, in operation 512. In particular, a specific quantity of resources of the second data record, having been converted, are used for causing the first data record to be modified, in response to the detected trigger. The first data record is modified to reflect an increase in the quantity of resources as a result of the transfer.

If, on the other hand, there are no account actions defined for the second computer server in connection with the detected trigger, the computing system may determine or define suitable account actions (associated with the trigger) that can be executed by the second computer server. In at least some implementations, the computing system determines a mapping between triggers of the first data record and account actions by the second computer server (operation 514). That is, account actions are defined such that they may be suitably executed by the second computer server upon detecting a corresponding trigger in connection with the first data record. The computing system, responsive to determining that there are sufficient resources in the second data record, executes a newly defined account action, in operation 518.

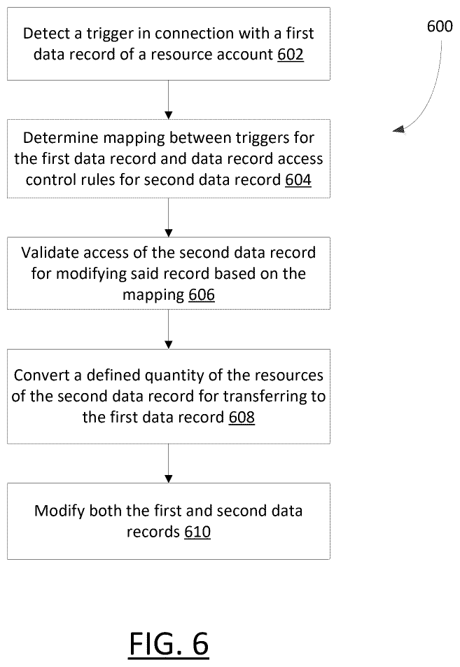

Reference is now made to FIG. 6 which shows, in flowchart form, an example method 600 for controlling access to a data record. The method 600 may be implemented by a standalone computing system, such as the loyalty management system 150, or by a resource account management system, such as the resource server 130, that is configured to integrate loyalty system functionalities. Operations 602 and onward may be performed by one or more processors of a computing device such as, for example, the processor 300 (FIG. 3A) of suitably configured instances of the example computing device 105 (FIG. 3A). The operations of method 600 may be performed in addition to, or as alternatives of, one or more of the operations of methods 400 and 500.

The computing system monitors account activities of a resource account in real-time. The resource account is associated with a first data record and a second data record. The data records are associated with different resource types. The account activities may include account-related operations (e.g., transactions such as deposits, withdrawals, purchases, internal/external transfers, etc.) that are conducted in connection with the resource account. In operation 602, the computing system detects a trigger in connection with the first data record associated with the resource account. The trigger may relate to a current quantity of resources associated with the first data record. For example, a trigger may be detected if the current quantity of resources is below a defined threshold. As another example, the computing system may detect a trigger upon determining that a current quantity-related indicator (e.g., an outstanding balance) for the first data record satisfies a certain condition.

The computing system then determines whether the resources of the second data record may be accessed for performing an account action relating to the detected trigger. More specifically, in operation 604, the computing system determines a mapping between triggers for the first data record and data record access control rules for the second data record. The data record access control rules define the conditions under which resources of the second data record may be accessed. Account actions involving access of resources of the second data record may be executed only if they comply with the requirements defined by the data record access control rules. For example, outbound transfers of resources of the second data record must comply with the data record access control rules in order to be processed. More generally, any account action that affects the quantity of resources associated with the data record is required to be in compliance with the relevant data record access control rules.

In operation 606, the computing system validates access of the second data record based on the mapping. In particular, the computing system verifies that a requested access of the second data record complies with requirements set forth in the data record access control rules for the second data record. For example, the computing system may determine, based on parameters of the requested account action, that the action is one that is permitted by the data record access control rules associated with the second data record. The validation of the access request has the effect of “unlocking” the resources of the second data record for account actions that are triggered by conditions, events, etc. associated with the first data record.

Once the requested access has been validated, the computing system converts a defined quantity of the resources of the second data record for transferring to the first data record (operation 608). By executing the transfer, the total quantity of resources associated with the first data record may be incremented. In particular, the computing system modifies both the first and second data records, in operation 610. The data records are modified to reflect the changes to the respective quantities of resources contained in the data records.

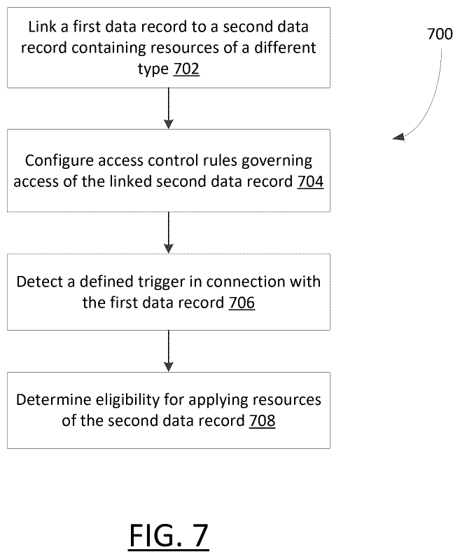

Reference is now made to FIG. 7 which shows, in flowchart form, an example method 700 for managing linked data records associated with a resource account. The method 700 may be implemented by a standalone computing system, such as the loyalty management system 150, or by a resource account management system, such as the resource server 130, that is configured to integrate loyalty system functionalities. Operations 702 and onward may be performed by one or more processors of a computing device such as, for example, the processor 300 (FIG. 3A) of suitably configured instances of the example computing device 105 (FIG. 3A). The operations of method 700 may be performed in addition to, or as alternatives of, one or more of the operations of methods 400, 500, and 600.

A resource account having multiple associated data records may benefit from automated transfers of resources between said data records. One approach for implementing such transfers is to connect data records having resources, or pool of resources, that are available and permitted to be transferred. By way of example, a first data record associated with the resource account may be linked to a second data record having available resources. In some implementations, the first data record may be connected to a plurality of data records that have resources available for inter-record transfers. In operation 702, the computing system links a first data record to a second data record containing resources of a different type. In at least some implementations, the second data record may be an account, such as a loyalty points account, that accrues resources based on account activities (e.g., transactions) that are conducted in connection with the first data record.

In operation 704, the computing system configures access control rules governing access of the linked second data record. The access control rules define the conditions under which resources of the second data record may be accessed. Account actions involving access of resources of the second data record may be executed only if they comply with the requirements defined by the access control rules. By allowing for automated transfers of resources, the computing system can ensure that requirements for maintaining the first data record in good standing can be met automatically. An important technical advantage of this approach of connecting data records of different resource types is that account activities of the first data record allow for accruing resources, such as loyalty points, in a linked second data record, while the accrued resources may be selectively accessed in order to automatically execute account actions for maintaining the first data record in good standing.

In operation 706, the computing system detects a defined trigger in connection with the first data record. The trigger may be any one of the different triggers discussed above with reference to FIGS. 4 to 6. For example, the trigger may relate to the quantity of resources, or other data-record specific indicator, associated with the first data record. The computing system then determines eligibility for applying resources of the second data record, in operation 708.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor; and
a memory coupled to the processor, the memory storing computer-executable instructions that, when executed by the processor, configure the processor to:
monitor operations of a resource account, the resource account being associated with a first data record containing resources of a first type and a second data record containing resources of a second type;
detect a trigger based on monitoring the operations;
in response to detecting the trigger:
determine a first quantity of resources of the first type for converting to the second resource type based on defined resource transfer rules;
convert the first quantity of the resources of the first type to a second quantity of the resources of the second type; and
cause a transfer of the second quantity of the resources of the second type to the second data record.

2. The computing system of claim 1, wherein detecting the trigger comprises determining that a required transfer of a defined minimum quantity of resources of the second type to the second data record has not been received by a specified time.

3. The computing system of claim 1, wherein detecting the trigger further comprises determining that the first data record contains sufficient quantity resources of the first type for converting to the minimum quantity of resources of the second type and wherein the second quantity is equal to the minimum quantity.

4. The computing system of claim 1, wherein detecting the trigger comprises:
determining that a transfer of a minimum quantity of resources of the second type to the second data record is required by a specified time; and
detecting a transfer of resources to the second data record that is less than the minimum required quantity.

5. The computing system of claim 1, wherein the first resources comprise digital resources that are allocated to the resource account based on historical account operations.

6. The computing system of claim 1, wherein the defined resource transfer rules indicate a rate of conversion between resources of the first type and resources of the second type.

7. The computing system of claim 1, wherein converting the first quantity of the resources of the first type to the second quantity of resources of the second type comprises modifying the first data record to represent an adjustment of resources of the first type associated with the resource account.

8. The computing system of claim 1, wherein the defined resource transfer rules indicate a maximum quantity of resources of the first type that is available for converting to resources of the second type.

9. The computing system of claim 1, wherein causing the transfer of the second quantity of the resources of the second type comprises incrementing a quantity of resources contained in the second data record based on the transfer.

10. The computing system of claim 1, wherein the resource account is associated with a value transfer card and wherein the second data record includes an indication of an outstanding balance associated with the value transfer card.

11. A computer-implemented method, comprising:
monitoring operations of a resource account, the resource account being associated with a first data record containing resources of a first type and a second data record containing resources of a second type;
detecting a trigger based on monitoring the operations;
in response to detecting the trigger:
determining a first quantity of resources of the first type for converting to the second resource type based on defined resource transfer rules;
converting the first quantity of the resources of the first type to a second quantity of resources of the second type; and
causing a transfer of the second quantity of the resources of the second type to the second data record.

12. The method of claim 11, wherein detecting the trigger comprises determining that a required transfer of a defined minimum quantity of resources of the second type to the second data record has not been received by a specified time.

13. The method of claim 11, wherein detecting the trigger further comprises determining that the first data record contains sufficient quantity resources of the first type for converting to the minimum quantity of resources of the second type and wherein the second quantity is equal to the minimum quantity.

14. The method of claim 11, wherein detecting the trigger comprises:
determining that a transfer of a minimum quantity of resources of the second type to the second data record is required by a specified time; and
detecting a transfer of resources to the second data record that is less than the minimum required quantity.

15. The method of claim 11, wherein the first resources comprise digital resources that are allocated to the resource account based on historical account operations.

16. The method of claim 11, wherein the defined resource transfer rules indicate a rate of conversion between resources of the first type and resources of the second type.

17. The method of claim 11, wherein converting the first quantity of the resources of the first type to the second quantity of resources of the second type comprises modifying the first data record to represent an adjustment of resources of the first type associated with the resource account.

18. The method of claim 11, wherein the defined resource transfer rules indicate a maximum quantity of resources of the first type that is available for converting to resources of the second type.

19. The method of claim 11, wherein causing the transfer of the second quantity of the resources of the second type comprises incrementing a quantity of resources contained in the second data record based on the transfer.

20. The method of claim 11, wherein the resource account is associated with a value transfer card and wherein the second data record includes an indication of an outstanding balance associated with the value transfer card.
